(19) United States
(12) Patent Application Publication
(10) Pub. No.: US 2020/0398631 A1
(43) Pub. Date: Dec. 24, 2020

(54) SYSTEM FOR ESTIMATING BEHAVIOR OF VEHICLE

(71) Applicant: MANDO CORPORATION, Gyeonggi-do (KR)

(72) Inventor: Min Sang SEONG, Gyeonggi-do (KR)

(21) Appl. No.: 16/846,008

(22) Filed: Apr. 10, 2020

(30) Foreign Application Priority Data
Jun. 24, 2019 (KR) 10-2019-0074955

(51) Int. Cl. B60G 17/0165; B60G 17/019; B60G 17/0195; B60W 10/22; B60W 30/04

(52) U.S. Cl. CPC B60G 17/0165; B60G 17/01908; B60W 30/04; B60W 10/22; B60G 17/0195

(57) ABSTRACT

Provided is a system for estimating behavior of a vehicle to control damping force of a variable damper installed between an axle and a vehicle body. The system includes four dampers installed in wheels, two or more wheel sensors configured to detect vertical velocities of wheels, one integrated sensor installed on one side of the vehicle body, and an electronic control unit (ECU) configured to control damping force of the dampers on the basis of a roll value, a pitch value, and a bounce value of the vehicle body estimated through the integrated sensor and the vertical velocities of the wheels.

### CROSS-REFERENCE TO RELATED APPLICATION

This application claims priority to and the benefit of Korean Patent Application No. 2019-0074955, filed on Jun. 24, 2019, the disclosure of which is incorporated herein by reference in its entirety.

### BACKGROUND

### 1. Field of the Invention

The present invention relates to a system for estimating vehicle behavior using an integrated sensor, and more particularly, to a vehicle behavior estimation system in which a single integrated sensor for estimating behavior of a vehicle to control the damping force of a damper is installed at the center of the vehicle so that multiple sensors and connection wires are omitted.

### 2. Discussion of Related Art

Generally, a suspension is installed between a vehicle wheel and a vehicle body to improve a riding feeling. Such a suspension includes chassis springs for absorbing vibrations or impact of a road surface and dampers for damping free vibrations of the chassis springs to improve the riding feeling.

The dampers serve to absorb free vibrations of the chassis springs by converting the energy of vertical motion into thermal energy and also serve to rapidly dissipate the thermal energy. Recently, after a state of a vehicle body is sensed through a sensor, the sensing result is fed back to electrically control the damping force of a damper.

To electrically control the damping force of a damper, it is necessary to accurately sense the state of a vehicle body. Therefore, a vehicle behavior estimation sensor for the purpose should be installed in the vehicle.

Referring to FIG. 1, according to the related art, a suspension control system 10, which estimates and controls behavior of a vehicle, not only includes a wheel vertical-acceleration sensor which is installed on a wheel to detect a vertical velocity of an axle but also includes three vertical acceleration sensors B1 to B3 in left and right front wheels and a right (or left) rear wheel of the vehicle to detect a vertical velocity of the vehicle body.

As such, at least three vertical acceleration sensors are installed at three or more positions to detect acceleration in a vertical direction of a vehicle and calculate a vertical velocity of the vehicle body. Then, motion of the vehicle body may be estimated.

However, the existing suspension control method employs three vertical acceleration sensors, and thus the three vertical acceleration sensors should be connected to an electronic control unit (ECU) 12 through wires.

Consequently, the number of sensors increases, and the number of processes for designing a wire path increases.

### SUMMARY OF THE INVENTION

The present invention is directed to a vehicle behavior estimation system for estimating behavior of a vehicle through a single integrated sensor without installing three or more sensors to estimate vehicle behavior.

According to an aspect of the present invention, there is provided a system for estimating behavior of a vehicle to control damping force of a variable damper installed between an axle and a vehicle body, the system including four dampers each installed on wheels, two or more wheel sensors configured to detect vertical velocities of wheels, one integrated sensor installed on one side of the vehicle body, and an electronic control unit (ECU) configured to control damping force of the dampers on the basis of a roll value, a pitch value, and a bounce value of the vehicle body estimated through the integrated sensor and the vertical velocities of the wheels.

The wheel sensors may include vertical acceleration sensors installed on the axle, and the vertical acceleration sensors may be installed on a front-axle left wheel to sense a left front vertical acceleration of the axle and installed on a front-axle right wheel to sense a right front vertical acceleration value of the axle.

The wheel sensors may include height sensors, and the height sensors may measure a relative distance between a front-axle left wheel and the vehicle body and a relative distance between a front-axle right wheel and the vehicle body.

The ECU may derive the bounce value, the roll value, and the pitch value using a vehicle dynamics model.

The integrated sensor may additionally measure a yaw value, Acc_x, and Acc_y to compensate for an installation angle of the integrated sensor which is installed on the vehicle body.

The integrated sensor may be installed outside the ECU.

The integrated sensor may be positioned at a gravity center of the vehicle.

The integrated sensor may be positioned at a geometric center of area of the vehicle.

The integrated sensor may be installed inside the ECU, and the ECU may not be installed at a gravity center of the vehicle.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 shows a structure of a system for estimating behavior of a vehicle according to a related art;

FIG. 2 shows a structure of a system for estimating behavior of a vehicle according to an exemplary embodiment of the present invention; and

FIG. 3 is a plan view of the system for estimating behavior of a vehicle according to the exemplary embodiment of the present invention.

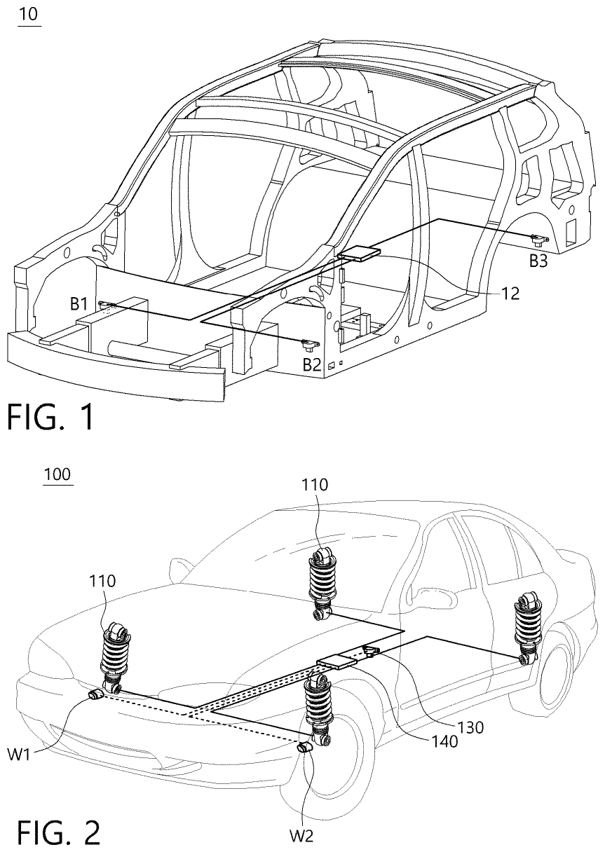

### DETAILED DESCRIPTION OF EXEMPLARY EMBODIMENTS

Advantages and features of the present invention and methods for achieving the same will become apparent with reference to exemplary embodiments described in detail below together with the accompanying drawings. However, the present invention is not limited to the embodiments set forth herein but may be implemented in various different forms. Rather, the embodiments are provided to make this disclosure complete and fully convey the scope of the invention to those of ordinary skill in the art. The invention is merely defined by the scope of the claims. In the drawings, sizes and relative sizes of elements and parts may be exaggerated for the clarity of description. Throughout this specification, like numerals refer to like elements.

The embodiments disclosed herein will be described with reference to plan views and cross-sectional views by way of an ideal schematic view of the present invention. Accordingly, exemplary views may be modified depending on manufacturing technologies and/or tolerances. Therefore, the embodiments of the present invention are not limited to those shown in the views but include modifications in configuration formed on the basis of manufacturing processes. Consequently, regions illustrated in the drawings have schematic attributes and may exemplify shapes of regions of equipment. However, such illustrated attributes and shapes do not limit the scope of the invention.

Hereinafter, a system for estimating vehicle behavior according to an exemplary embodiment of the present invention will be described in detail with reference to the accompanying drawings.

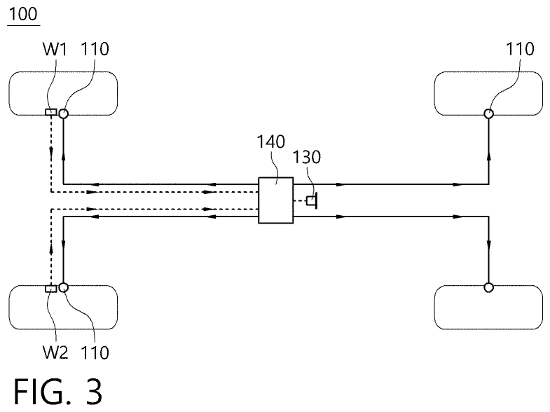

Referring to FIGS. 2 and 3, to control damping force of a variable damper installed between an axle and a vehicle body, a system 100 for estimating behavior of a vehicle includes four variable dampers 110 installed on wheels, two or more wheel sensors W1 and W2 for detecting vertical velocities of wheels, one integrated sensor 130 installed on one side of the vehicle body, and an electronic control unit (ECU) 140 for controlling damping force of the dampers on the basis of a roll value, a pitch value, and a bounce value of the vehicle body estimated through the integrated sensor 130 and the vertical velocities of the wheels detected through the wheel sensors W1 and W2.

The damping force of the dampers 110 may be adjusted through one or more adjustable damping valves.

Each of the wheel sensors W1 and W2 includes a wheel vertical-acceleration sensor. A wheel vertical-acceleration sensor detects a vertical gravitational acceleration at each wheel. For example, a wheel vertical-acceleration sensor is installed in a front-axle left wheel and senses a front-axle left vertical acceleration value, and another wheel vertical-acceleration sensor is installed in a front-axle right wheel and senses a front-axle right vertical acceleration value.

In this case, left and right vertical acceleration values of a rear-axle may be estimated using the front-axle vertical acceleration values. For example, left and right vertical acceleration values of the rear-axle may be calculated from the front-axle left and right vertical acceleration values using an estimation algorithm.

Therefore, a vertical velocity of each wheel may be calculated by integrating a vertical acceleration value of the wheel. The acquired vertical velocity of each wheel may be added to a vertical velocity of the vehicle body, which will be described below, to determine the amount of control over each damper.

The vertical velocity of each wheel is not necessarily calculated through the above-described vertical acceleration sensors. For example, the vertical velocity of each wheel may be acquired through two or four height sensors, wheel velocity sensors, or the like. When height sensors are used, a relative distance between an axle and the vehicle body may be measured in a z-axis direction.

The single integrated sensor 130 may calculate a roll value, a pitch value, and a bounce value (e.g., a vertical velocity) of the vehicle body from sensor signal values using a vehicle dynamics model and estimate behavior of the vehicle. In addition, operating speed, acceleration, etc. of a damper may be estimated from a wheel acceleration signal.

In general, vehicle behavior is estimated from a left front vertical acceleration value of a vehicle body detected by a left front sensor of the vehicle body, a right front vertical acceleration value of the vehicle body detected by a right front sensor of the vehicle body, and a left rear vertical acceleration value of the vehicle body detected by a left rear sensor of the vehicle body. On the contrary, according to the exemplary embodiment of the present invention, the integrated sensor 130 may estimate vehicle behavior using pitch, roll, and bounce of the vehicle body estimated on the basis of a kinematics model as parameters.

The integrated sensor 130 may be installed at different angles with respect to the vehicle body, and thus it is necessary to measure 6-axis signals including a pitch value, a roll value, a yaw value, Acc_x (a front-back velocity), Acc_y (a left-right velocity), and Acc_z (a vertical velocity) and compensate for the installation angle of the integrated sensor 130 with respect to the vehicle body.

According to the above configuration of the present invention, it is possible to expect cost reduction due to a decrease in the number of sensors and reduce the number of processes by omitting paths for data transmission wires.

Here, the pitch value defines a straight line motion along an x-axis (a front-back velocity) and a rotary motion about a y-axis. The roll value defines a straight line motion along the y-axis (a left-right velocity) and a rotary motion about the x-axis. The yaw value defines a straight line motion along the z-axis (an up-down velocity) and a rotary motion about the z-axis.

The integrated sensor 130 may be positioned at the gravity center of the vehicle. The integrated sensor 130 may be separately configured outside the ECU 140.

The integrated sensor 130 may be positioned at the centroid of the vehicle. In this case, the integrated sensor 130 may be positioned at the gravity center of the vehicle or the geometric center of area of the vehicle.

The integrated sensor 130 is smaller than the ECU 140 and thus has a high degree of freedom of sensor positioning. For example, when the integrated sensor 130 is integrated with the ECU 140, it may be difficult to determine a position of the ECU 140 considering rigid body conditions for sensor attachment and the like. When the integrated sensor 130 is provided separately from the ECU 140, it is easy to maintain the integrated sensor 130 and the ECU 140. In other words, when the integrated sensor 130 malfunctions, it is possible to replace only the integrated sensor 130.

However, the integrated sensor 130 may be installed in the ECU 140. In this case, the ECU 140 is not necessarily installed at the gravity center of the vehicle.

As described above, according to the exemplary embodiment of the present invention, it is possible to expect the following effects.

First, multiple sensors and wires connecting the sensors can be omitted, and thus it is possible to expect the economic effect of cost reduction.

Second, an integrated sensor is not necessarily installed on a front, left, or right side of a vehicle and can be installed at an appropriate position around the gravity center or geometric center rather than an exact position of the gravity center or geometric center. Therefore, it is possible to install the integrated sensor at will, and it is easy to replace the installed integrated sensor.

As described above, while a current electronically controlled suspension system estimates movement of a vehicle using three vertical acceleration sensors and thus requires wiring from an ECU to three points in the vehicle body, the technical spirit of the present invention relates to a structure for estimating movement of a vehicle body using one integrated sensor. When the technology of the present invention is applied to a vehicle, it is possible to reduce costs by decreasing the number of sensors and reduce the number of processes for designing a wire path. It will be apparent to those of ordinary skill in the art that various modifications can be made to the above-described exemplary embodiment of the present invention without departing from the technical spirit and scope of the present invention.

What is claimed is:

1. A system for estimating behavior of a vehicle to control damping force of a variable damper installed between an axle and a vehicle body, the system comprising:
four dampers each installed in wheels;
two or more wheel sensors configured to detect vertical velocities of wheels;
one integrated sensor installed on one side of the vehicle body; and
an electronic control unit (ECU) configured to control damping force of the dampers on the basis of a roll value, a pitch value, and a bounce value of the vehicle body estimated through the integrated sensor and the vertical velocities of the wheels.

2. The system of claim 1, wherein the wheel sensors include vertical acceleration sensors installed on the axle, and
the vertical acceleration sensors are installed on a front-axle left wheel to sense a left front vertical acceleration of the axle and installed on a front-axle right wheel to sense a right front vertical acceleration value of the axle.

3. The system of claim 1, wherein the wheel sensors include height sensors, and
the height sensors measure a relative distance between a front-axle left wheel and the vehicle body and a relative distance between a front-axle right wheel and the vehicle body.

4. The system of claim 1, wherein the ECU derives the bounce value, the roll value, and the pitch value using a vehicle dynamics model.

5. The system of claim 4, wherein the integrated sensor additionally measures a yaw value, Acc_x, and Acc_y to compensate for an installation angle of the integrated sensor installed in the vehicle body.

6. The system of claim 1, wherein the integrated sensor is installed outside the ECU.

7. The system of claim 6, wherein the integrated sensor is positioned at a gravity center of the vehicle.

8. The system of claim 6, wherein the integrated sensor is positioned at a geometric center of area of the vehicle.

9. The system of claim 1, wherein the integrated sensor is installed inside the ECU, and
the ECU is not installed at a gravity center of the vehicle.
